(19) United States
(12) Patent Application Publication
(10) Pub. No.: US 2017/0330287 A1
(43) Pub. Date: Nov. 16, 2017

(54) SYSTEMS AND METHODS FOR TRANSACTION-BASED PROCESSING

(71) Applicant: Creditron Canada, Inc., Mississauga (CA)

(72) Inventors: Ewald Vogel, Mississuaga (CA); James McGuire, Milton (CA); Ross Wozniak, Merrimack, NH (US); Alex Vasquez, Stafford, VA (US)

(21) Appl. No.: 15/594,062

(22) Filed: May 12, 2017

Related U.S. Application Data
(60) Provisional application No. 62/335,472, filed on May 12, 2016.

(30) Foreign Application Priority Data
May 12, 2016 (CA) 2929919

(51) Int. Cl. G06Q 40/00; G06Q 10/06

(52) U.S. Cl. CPC G06Q 40/12; G06Q 10/0633

(57) ABSTRACT

In various embodiments, described herein are systems and methods for transaction-based integrated receivables processing. In one embodiment a management computing entity may receive batches and/or trays, which may refer to groups of transactions that enter a workflow together. The management computing entity may disintegrate these trays into individual transactions. Then, each transaction may be allowed to follow to a differential path through any processing workflows. Further, batches may be created from the processed individual transactions at predetermined cut-off events for final output from the system. The disclosed systems and methods may enable the transactions to be handled independently and individually, increasing efficiency while simultaneously augmenting and enhancing audit information for compliance purposes.

### RELATED APPLICATIONS

This application claims priority to U.S. Provisional Patent Application No. 62/335,472, entitled “Systems and Methods for Transaction-Based Processing,” filed on May 12, 2016 and Canadian Application No. 2,929,919, entitled “Systems and Methods for Transaction-Based Processing,” filed on May 12, 2016, the contents of both applications are incorporated by reference herein in their entirety.

### BACKGROUND

Various approaches to the processing of receivable payments, including check, credit card, and electronic payments (which may also be referred to as lockbox processing) by various banking computers may involve batches, where a batch may refer to a group of transactions.

### BRIEF DESCRIPTION OF THE DRAWINGS

Reference will now be made to the accompanying drawings, which are not necessarily drawn to scale, and wherein:

FIG. 1 shows a diagram of an example computing environment in accordance with example embodiments of this disclosure.

FIGS. 2A-2C shows a diagram of an example of the management computing system and/or Enterprise Cloud Processing (ECP) system in accordance with example embodiments of this disclosure.

FIGS. 3A and 3B shows a diagram of a further example operation of the management computing system and/or ECP system in accordance with example embodiments of this disclosure.

FIG. 4 is an overview of a system that may be used to practice embodiments of the present disclosure.

FIG. 5 is an exemplary schematic diagram of a screening computing system according to one embodiment of the present disclosure.

FIG. 6 is an exemplary schematic diagram of a consumer computing entity according to one embodiment of the present disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar but not necessarily the same or identical components; different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

Particular embodiments of the subject matter described herein may be implemented so as to realize one or more of the following improvements: provide accurate and efficient methods for processing of integrated receivables by one or more bank computers and/or servers. In turn, this increases the speed of operation and reduces the computation stress on servers and components responsible for the processing and tracking of the integrated receivables comprising various individual transactions by one or more bank computers and/or servers. This may facilitate faster performances for, at least, exception handling during the course of the processing of the integrated receivables comprising various individual transactions by one or more bank computers and/or servers. Image-enabled payment processing and receivables automation may benefit organizations of various sizes, across many industries.

The systems and methods described herein may be directed to a process for managing receivables (also referred to as lockbox)—with check, credit card, and electronic payments, that may reduce the need for manual preparation of batches based on similarity of transactions, instead using image capturing and electronic data extraction, and an intelligent and customizable process for managing the work in progress with exception handling (e.g., corrections) and classification of transactions into customer relevant output batches that may be passed to customer applications and/or delegates (e.g., financial institutions) to reduce the transit time (e.g., float) between receipt and deposit of payments.

The systems and method described herein may be directed to a process to manage transaction-based integrated receivables processing by means of a dynamic view of work in progress and the ability to govern people assignments based on evolving priorities or deadlines, to maximize productivity in a virtual work environment with a real time allocation of collaborating resources in a local end/or distributed operation. An integration receivables platform may be a payment hub that consolidates incoming receivables (e.g., electronic and paper-based transactions) and incoming payments. In one embodiment, payments and remittance data from multiple sources (e.g., lockbox, remote capture, wire, ACH, cards, web/mobile) may be amalgamated into one integrated output file. The platform may also allow for the onboarding of additional payment channels as need arises—an opportunity to leverage shared points of connection to enabled straight-through processing that reduces labor-intensive manual processing and accelerates the application of cash and the handling of exception items.

Integrating payment and remittance data from disparate sources may reduce the need to report on and aggregate data from multiple silos, instead allowing an organization to collect and analyze the information from the central hub. This allows for immediate visibility & direct access to historical and trending data to better inform the decision-making process.

In some embodiments, end-to-end image-based platforms may be used to automate processing remittance documents across various payment applications, an aspect of maintaining cash flow, improving customer service, generating recurring revenue and reducing overall costs associated with processing payments. In some embodiments, lockbox processing may use robust solutions that may allow retail, wholesale, and whole-tail processing on a single platform. The disclosure combines advanced imaging, data recognition and workflow technologies with user-defined business rules and processes to drive down operational costs, increase revenues, enhance customer service and give lockbox providers a competitive edge.

The systems and methods described herein may support different payment instruments and supporting documentation. Whereas traditionally this operation may need manual effort to open the mail, extract envelope contents, sort by type of remittance, and create batches by type of remittance, the systems and methods described herein may bypass aspects of this preparation (for example, intercepting currency included with a remittance) so that over 99% of transactions may be scanned and converted to images. Physical document contents may then be filed off-site at a secure storage facility until the items can be destroyed.

With automated data extraction from images, and configurable remittance rules, enterprise cloud processing (ECP) may identify where manual intervention may be required: those exceptions may be placed in specific queues for operators to enter corrections. The systems and methods described herein are directed to different queues that facilitate separation of duties as required. For example, lockbox processing clients may have exception queues to manage their own data correction. In some embodiments, individual transactions may not hold up a batch, and slow down operations, because transactions may be managed as independent from each other.

When the data passes through the exception filters, ECP may perform aggregation and reporting services, as well as output payment files to selected banks while payment data may be forwarded to customer payment systems for bank reconciliation and account updating. ECP may have configurable export processes to accommodate a number of bank interface file standards as well as flexible file generation tools to supply data for the client owned business processes (such as enterprise resource planning (ERP) applications). During this output stage, traditional batch output may be produced to accommodate the expectations of legacy customer system.

ECP may support long-term storage of remittance information for client certificate signing request (CSR) operators to search, as it has the image data showing the original documents that made up the remittance transactions. It allows the data to be downloaded, printed, and/or emailed to consumers or businesses that made the remittance.

In some embodiments, exception processing may offer user-friendly interfaces designed specifically to offer users or clients a streamlined and accessible exception management experience. Exceptions may include a mismatch of the numerical and hand written amount of a check, an incorrect invoice number noted on the remittance advice, an under- or over payment of an account and/or invoice, missing signature on a check, payment for an account who's services have been disabled or an insurance policy that has not been approved, and so on. The handling of exceptions can be approximately 90% of the effort and cost of operations.

In various existing approaches, transactions may be tied to batches they are a member of, and the tracking of the transactions through various receivables process workflows may be performed at the batch level. Further, in these approaches, batches may enter various processing workflows for processing, and later, the processed batches may leave the workflow to allow various users (for example, bank employers) to take action based on the results of the workflow.

In some embodiments remittance processing from a number of branch locations may be integrated for improved cash management for the organization: bank reports will be used for reconciliation rather than for cash planning purposes. The processing may be segregated with regional data capture operations feeding into a centralized ECP system that may be operated from a centralized operations center or from centers distributed in different locations (e.g., the “cloud” model). The entire operation may be managed via a centralized workflow dashboard that has visibility into the work in progress.

ECP may flexibly integrate with existing client operations using a dynamic configuration approach so that their operations workflow can be mapped into the ECP services. ECP may support a lockbox client portal so that it can be used as a service platform that provides Integrated Receivables Processing for external business organizations (e.g., using lockbox operations) that have real-time insight into their receivables, where ECP operates as a configurable appliance for client remittances (e.g., a service bureau paradigm).

In some embodiments, transactions may be automatically validated and automated rules may be applied so that items may be routed to a relevant exceptions queue for review and/or manual intervention as required. Exception codes may reflect client environments and may be dynamically configured. The exceptions may be tracked and monitored through a real-time dashboard. Administrators may have visibility to the entire remittance process to automatically assign resources and to change priorities as may be needed in order to maintain productivity. A single transaction may be queried to view the process, enhancing controls and accountability.

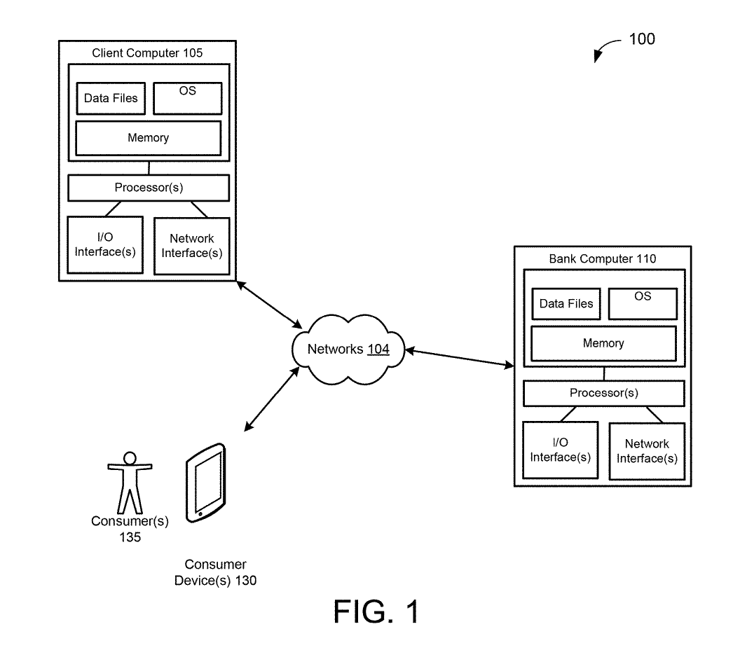

FIG. 1 shows an example diagram of a management computing system 100 (alternatively or additionally referred to as Enterprise Cloud Processing (ECP) system herein) for consumers 135, banks, and bank clients according to one example embodiment of the disclosure. In one example the management computing system 100 may include one or more of a client computer 105, a bank computer 110, one or more consumer device(s) 130 (alternatively or additionally referred to as user computing entities 130 herein) that the management computing system 100 manages. In various embodiments, the management computing system 100 may be communicatively coupled via one or more networks 104 and one or more computers at the various sites (for example, the bank site, the client site) and consumer device(s) 130, for example, a cell phone associated with a consumer 135, or a computer associated with a site, for example, a client site. In one example embodiment, the client computer 105, the bank computer 110, and the consumer device 130 may include one or more processors that may be configured for accessing and reading associated computer-readable media having stored data thereon and/or computer-executable instructions for implementing various embodiments of the disclosure.

Generally, network devices and systems, including the management computing system 100, the client computer 105, the bank computer 110, and the consumer device 130, may include or otherwise be associated with suitable hardware and/or software for transmitting and receiving data and/or computer-executable instructions over one or more communication links or networks, for example, networks 104. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIG. 1, the client computer 105, the bank computer 110, and the consumer device 130 may be in communication with each other via one or more networks, such as network 104, which may include one or more independent and/or shared private and/or public networks including the Internet or a publicly switched telephone network. In other example embodiments, one or more components of the management computing system 100 may communicate via direct connections and/or communication links. These components—the client computer 105, the bank computer 110, and the consumer device 130—will now be discussed collectively in further detail. Although the components are generally discussed as singular components, as may be implemented in various example embodiments, in alternative exemplary embodiments each component may include any number of suitable computers and/or other components.

With continued reference to FIG. 1, the client computer 105, the bank computer 110, and the consumer device 130 may include a computing device that includes any number of server computers, mainframe computers, networked computers, desktop computers, personal computers, mobile devices, smartphones, digital assistants, personal digital assistants, tablet devices, Internet appliances, application-specific integrated circuits, microcontrollers, minicomputers, and/or any other processor-based devices. The client computer 105, the bank computer 110, and the consumer device 130 having computer-executable instructions stored thereon may form a special-purpose computer or other particular machine that is operable to facilitate the processing of transactions/requests for information made by or on behalf of the various sites and the communication of requested information. Additionally, in certain embodiments, the operations and/or control of the client computer 105, the bank computer 110, and the consumer device 130 may be distributed among several processing components. In addition to including one or more processors, the components (the client computer 105, the bank computer 110, and the consumer device 130) may further include one or more memory devices (or memory), one or more input/output (“I/O”) interfaces, and one or more network interfaces. The memory devices may be any suitable memory devices, for example, caches, read-only memory devices, random access memory devices, magnetic storage devices, removable storage devices, etc. The memory devices may store data, executable instructions, and/or various program modules utilized by the client computer 105, the bank computer 110, and the consumer device 130, for example, data files, and an operating system (“OS”).

The OS may be a suitable software module that controls the general operation of the client computer 105, the bank computer 110, and the consumer device 130. The OS may also facilitate the execution of other software modules by the one or more processors. The OS may be any operating system known in the art or which may be developed in the future including, but not limited to, Microsoft Windows®, Apple OSX™, Apple iOS™, Google Android™, Linux, Unix, a mainframe operating system and/or the like.

The one or more I/O interfaces may facilitate communication between the client computer 105, the bank computer 110, and the consumer device 130 and one or more input/output devices, for example, one or more user interface devices, such as a display, keypad, control panel, touch screen display, remote control, microphone, etc., that facilitate user interaction with the client computer 105, the bank computer 110, and the consumer device 130. For example, the one or more I/O interfaces may facilitate entry of information associated with a testing request by an operator at a bank, for example, a bank teller or a bank supervisor. The one or more network interfaces may facilitate connection of the client computer 105, the bank computer 110, and the consumer device 130 to one or more suitable networks, for example, the network 104 illustrated in FIG. 1. In this regard, the client computer 105, the bank computer 110, and the consumer device 130 may receive and/or communicate information to other network components of the management computing system 100.

The management testing system 100 shown in and described with respect to FIG. 1 is provided by way of example only. Numerous other operating environments, system architectures, and device and network configurations are possible. Other system embodiments may include fewer or greater numbers of components and may incorporate some or all of the functionality described with respect to the system components shown in FIG. 1. For example, in an exemplary embodiment, bank computer 110 (or any other computer) may be implemented as a specialized processing machine that includes hardware and/or software for performing the methods described herein. Accordingly, embodiments of the disclosure should not be construed as being limited to any particular operating environment, system architecture, or device or network configuration.

In various embodiments, various entities, including, but not limited to, a consumer, a bank, and a bank client. The consumer may have a consumer device and/or computer 130, the bank may have a bank computer 110, and bank client may have a client computer 105 that may, in various example embodiments, communicate and exchange data over one or more networks. The networks may comprise a general network connection (e.g., through the Internet) or may comprise a direct connection between the entities using, for example, dedicated line(s).

In an embodiment, the transaction (for example, a donation or payment by a consumer) may be received by a lockbox at a bank computer 110. The bank may have a P.O. Box address. Alternatively, the transaction (for example, a donation or payment by a consumer) may be received by a virtual lockbox at a bank computer 110. For example, the bank may have a MasterCard Remote Payment and Presentment Service (RPPS).

In one embodiment, the ECP system may receive batches from one or more legacy systems. The ECP system may convert the batches to trays. In some embodiments, a batch may be converted to a tray. In some embodiments, several batches may be combined to one tray. The trays may be disintegrated, parsed, or otherwise separated into individual transactions and processed by the ECP system in accordance with example embodiments of the disclosure. One approach to processing receivables payments and lockboxes has been to monitor and manage the receivables payments and lockboxes using reports or status screens that show batches flowing through a defined work process. However, the approach may not provide the ability to dynamically monitor and assign work from specific lockboxes, and/or to monitor the productivity of individual operators, and/or dynamically assign them to work queues.

Furthermore, lockbox work may become backlogged or stuck in a bottleneck in an unmanaged workflow. This may result in missed deposits and posting deadlines. This problem may be compounded where a specific lockbox, customer, or department have a service-level agreement (SLA) that may affect work priority and deposit deadlines. When transactions associated with these type of SLA based lockboxes, customers, and/or departments are intermingled with other work, it may become difficult to expedite and/or prioritize this work.

One approach has been to pre-sort by lockbox priority before the work and the associated batches of transactions enter the processing system. The system may be allowed to run on a first-in-first-out (FIFO) basis. This approach may have several drawbacks. One drawback may be that once the priority status of work and the associated batches of transactions is set, they cannot be dynamically changed rapidly to respond to various circumstances including, but not limited to, specific backlogs and/or bottlenecks, specific operator performance, and/or specific lockbox urgency.

In various embodiments, described herein are systems and methods for transaction-based integrated receivables processing. In one embodiment a management computing entity may receive batches and/or trays, which may refer to groups of transactions that enter a workflow together. The management computing entity may disintegrate these trays into individual transactions. Then, each transaction may be allowed to follow to a differential path through any processing workflows. Further, batches may be created from the processed individual transactions at predetermined cut-off events for final output from the system. The disclosed systems and methods may enable the transactions to be handled independently and individually, increasing efficiency while simultaneously augmenting and enhancing audit information for compliance purposes.

For example, with conventional processes much of the audit trail information (for example, the date, operator, and payment type information) may be stored at the batch level, with each transaction inheriting information from the batch. By breaking this batch level grouping and making each transaction atomic, each transaction may include its own audit trail of information. This may also allow for a far greater level of detailed audit information as each transaction may carry its own specific information. This information no longer needs to be homogenous with the other transactions in a batch or a tray.

In some embodiments, the systems and methods described herein may be used eliminate the inefficiency of one exception transaction holding up other transactions in the same batch. This may be because each transaction flows independently through the workflow. In some embodiments, keying of transactions may be more granular and therefore more efficient. As such, multiple operators may key individual transactions without one locking an entire batch.

The ECP system may enable the management of a workflow lockbox. For example, for a hypothetical Acme corporation with 500 customers, the transactions for Acme corporation may be prioritized by lockbox, e.g., those transactions may be moved to the beginning of a given workflow queue, and/or every Acme transaction in every queue may move to a predetermined workflow queue.

Some embodiments may include real-time processing of individual transactions. This can, for example, allow for the realization of real-time automated Clearing House (ACH) payments, which were previously (in the non-real-time case) network batch based and further, rely on clearing houses. Some embodiments may include workflows becoming more granular and more efficient to process and track. Some embodiments may include enhanced integration with compliance, which may refer to checks and balances on the backend. For example, for a check scanned Monday at Publix by John Doe, a user may access the history of this individual transaction, rather than the inherited history of the batch from which the transaction was derived.

Further, as mentioned, in conventional batch-based systems, any exceptions that result from processing the batches may need to be carried over to the following day and may need to be removed from the original batch. This may result in a loss of audit trail information and may lead to compliance non-conformance. The disclosed transaction-based processing systems and methods may allow for exception processes to span across multiple days while retaining the original tray information. This may allow for the production of a complete and detailed audit trail for every transaction at every stage of workflow, even including viewing of a specific transaction in the archive, providing a previously unachievable level of audit information for compliance. Some embodiments may facilitate deposits of mixed input work to multiple depository accounts. Further, in various embodiments of the disclosure, the trays may still be processed as a unit, and the transactions may be tied to their respective tray as they were processed through the workflow, and later assigned to batches. As such, the disclosure treats the individual transactions with a new data structure that allows the transactions to be disintegrated from their respective tray and be processed independently.

In one embodiment, an interface, also referred to herein as an integrated receivables workflow management dashboard, may use the disclosed transaction-based integrated receivables processing systems and methods to enable the real-time monitoring and management of receivables workflow based on lockbox, work queue, and/or operators. The interface (e.g., the integrated receivables workflow dashboard) may allow for the real-time monitoring of every lockbox, every operator, and/or every work queue, and further permits the dynamic real-time reassignment of operators or prioritization of lockbox transactions. As a browser-based solution it allows this monitoring and management, even when the user is not physically in the processing site. In another embodiment, the user interface may be browser based (to allow workflow monitoring and management when away from the processing location).

In addition, certain user interface elements may be used to provide a richer user experience, including, for example, user interface the ability to easily use touchscreen devices. These user interface elements may allow one or more users to interact and dynamically impact work assignment and priority in a user-friendly browser-based environment.

In various embodiments, disclosed herein are systems and methods for receiving a batch at the input of an ECP system, converting the batch to one or more trays, with each tray comprising one or more transactions. In some embodiments, an import source (e.g., file, opex, etc.) may be converted to one tray. In some embodiments, a tray may be a collection of loosely grouped transactions. In a batch, the transactions may be totaled and related to each other (e.g., same cashier initiated them). These trays may then be disintegrated into individual transactions, which may then be processed through one or more workflows, for example, one or more workflows designed for a particular consumer. At the end of the workflows, the individual transactions may be optionally re-integrated into trays and/or batches. This may be done, for example, for ease of integration with one or more legacy systems.

In various embodiments, one or more external connections between the ECP system and one or more client systems and/or client system computers may be setup. This may allow, for example, the ECP system to integrate with the workflow of various clients. For example, if the client is a donation center, the ECP system may make various calls to the client system computers to obtain status information regarding gifts sent to donors. The status information may include a real-time inventory status for the gifts. Further, the ECP system may communicate with the client system computer to order said gifts for the donors. If the gifts are out of inventory, the ECP system may coordinate using the client system computers to order the gifts at a later time, or send different gifts that are in stock.

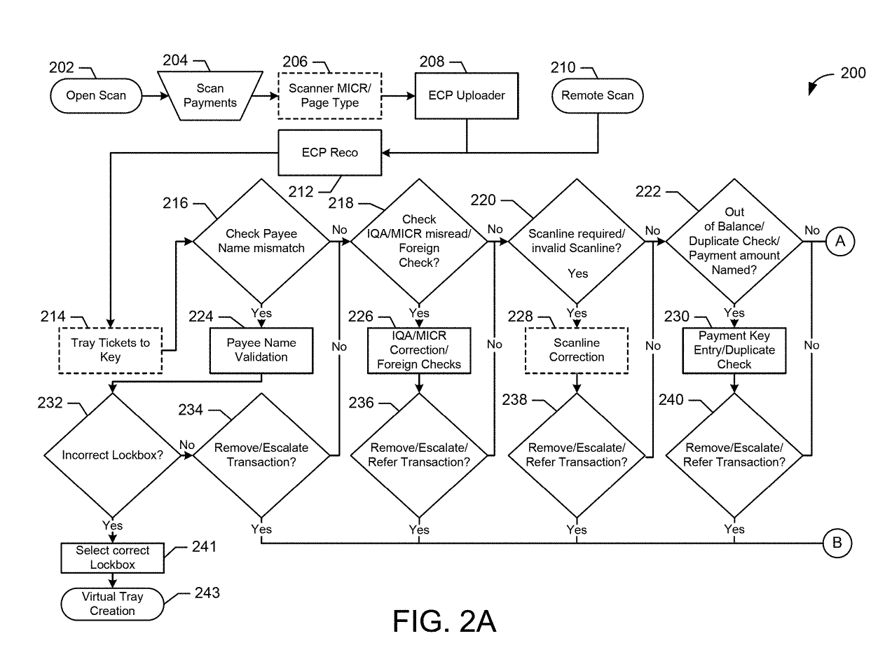

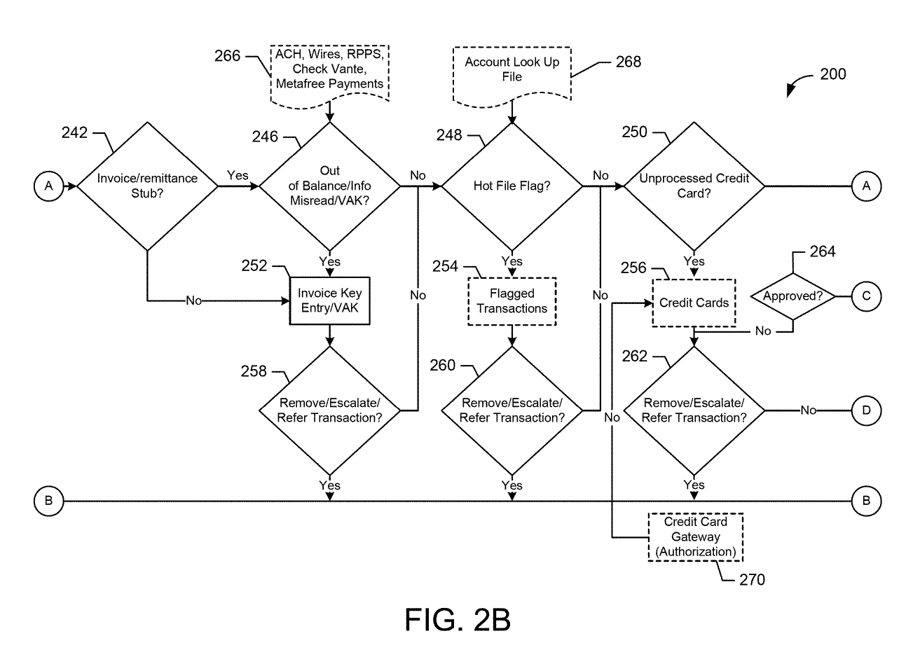

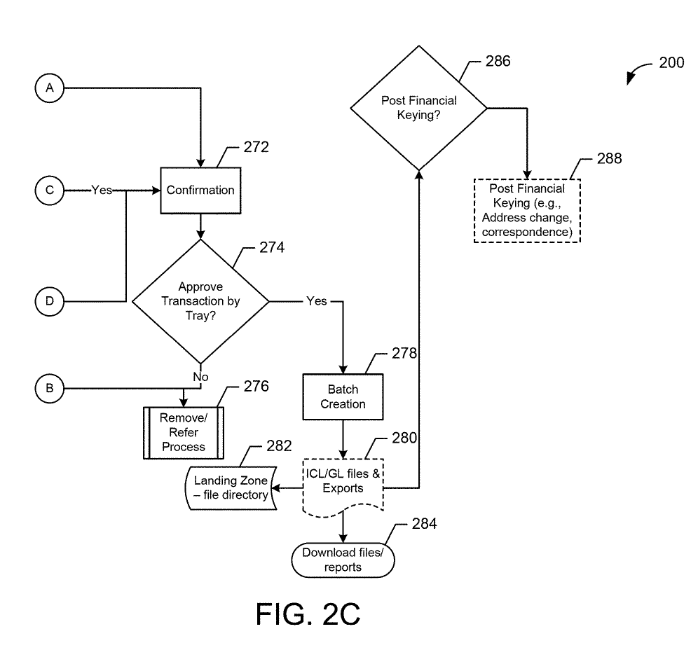

FIGS. 2A-2C shows an example work flow diagram 200 for the example operation of the ECP system, in accordance with example embodiments of the disclosure. At block 202, the ECP system may open a scan, scan payments at block 204, determine a scanner magnetic ink character recognition (MICR)/page type at block 206, and send to an ECP uploader at block 208. Moreover, the scanning may be performed by a specializing scanning device and/or a specialized computer having specialized instructions for the scanning. Alternatively or additionally, the ECP may perform a remote scan at block 210. In either case (e.g., opening the scan at block 202 and/or remote scanning at block 210), the information may be sent to an ECP Recognition (Reco) module at block 212 as part of an ECP decisioning and work queue functionality. The ECP Reco module at block 212 may determine whether to confirm or reject the scan, for example, if there are errors with the scanning process or the information received.

From here, the transaction/tray may be subject to a variety of tests to determine further processing by one or more operators as a part of a work queue functionality. The work queue functionality may pass information with the ECP Decisioning functionality. For example, the tray/transaction may be optionally ticketed to key at block 214. Then the tray/transaction may be checked for payee name mismatch at block 216 by a payee name validation module 224. This and various other types of tests (for example, an Image Quality Assurance (IQA)/MICR correction/foreign check at block 218, a scanline correction check at block 220, an out of balance/duplicate check/payment amount misread check at block 222, an invoice/remittance stub check, an out of balance/info missed/VAK check at block 246, a hot file flag check at block 248, and/or a unprocessed credit card check at block 250) may be performed in accordance with a workflow defined by a particular client. The result from the checks (216's) may be to perform predetermined processing (e.g., a payee name validation processing at block 224, an IQA/MICR correction/foreign processing at block 226, a scanline correction processing at block 228, a payment key entry/duplicate check processing at block 230, an invoice entry key/VAK at block 252 processing, a flagged transaction processing at block 254, and/or a credit card processing at block 256). After each respective processing, a remove/escalate transaction determination (e.g., blocks 234, 236, 238, 240, 262, 258, 260, and 262) may be made by the ECP system.

Further, if at the result of the payee name validation processing at block 224, the result is that there was an incorrect lockbox at block 232, then the correct lockbox may be selected at block 241, and a virtual tray may be created at block 243 as part of an output stage. Moreover, the out of balance/info misread/VAK check at block 246 may optionally receive ACH, wires, RPPS, Checkfree, and other forms of payments at block 266. Furthermore, the hot flag file check at block 248 may receive information from an optional account look up file at block 268. Additionally, if the result of the unprocessed credit card check at block 250 is negative then a confirmation processing at block 272 may be performed. From there an approve transaction tray check at block 274 may be performed. If the result of the approve transaction check is negative, then the process may be removed and/or referred at block 276.

At the end of the work queue, a batch may be created at block 278 with the processed transaction. This may be, for example, for the integration with one or more legacy systems. From here, the transaction, which may be a part of the batch, may be conditioned for ICL/GL files and exports format at block 280, and may either be stored at a Landing Zone at block 282 or in downloaded files/reports at block 284. Further, the batch (ICL)/General Ledger (GL) files and exports at block 280 may return to the ECP decisioning functionality and/or work queue functionality, and may be processed for post financial keying (e.g., blocks 286 and 288). The workflow queues may include, but not be limited to, for example, an account identification queue, a payee name queue, an electronic payment validation queue, and the like. Furthermore, the ECP system may allow for operators to be dragged and dropped between queues.

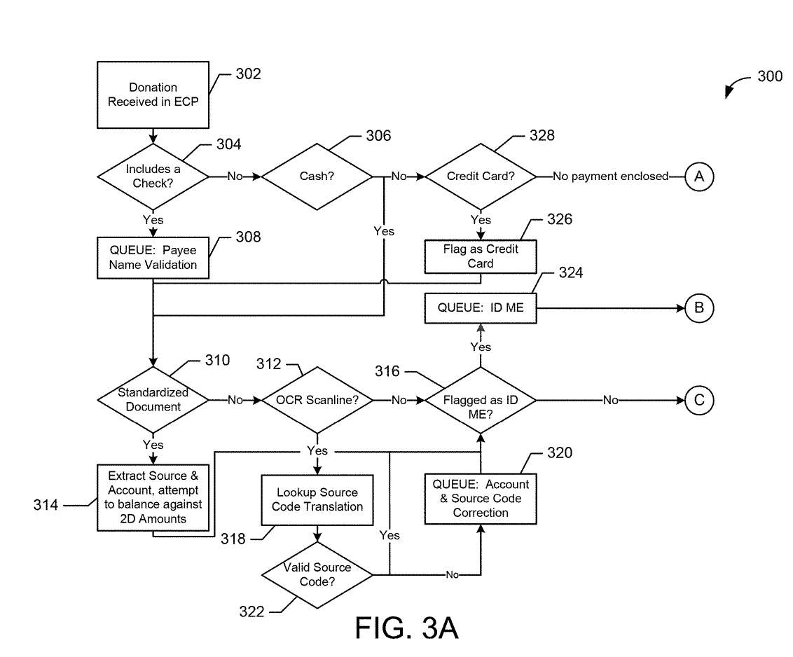

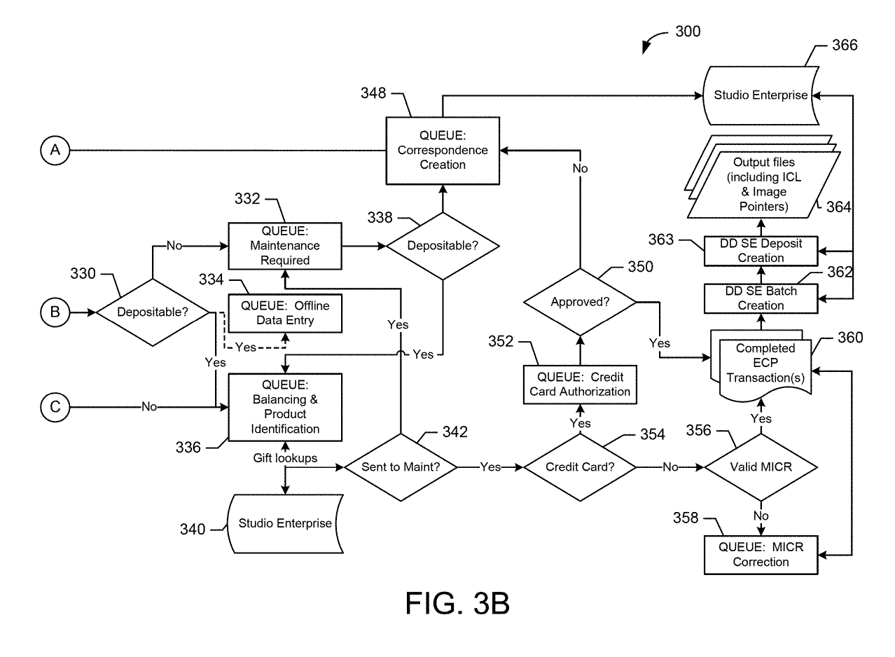

FIGS. 3A-3C shows a diagram of an example workflow in accordance with example embodiments of the systems and methods disclosed herein. At block 302, the donation may be received in the ECP system. At block 304, a determination may be made to determine if the donation includes a check. If it is determined that the donation includes a check, the operation proceeds to block 308. If it is determined that the donation does not include a check, then the operation may proceed to block 306. At block 306, a determination may be made whether the donation include cash. If the donation includes cash, the operation may proceed to block 310. If the donation does not include cash, the operation may proceed to block 328. At block 308, the payee name may be validated, for example, as a part of a queue work flow.

At block 310, it may be determined whether the document is standardized or not. If the document is a standardized document, then the operation may proceed to block 314. If the document is not a standardized document, then the operation may proceed to block 312. At block 314, the source and account may be extracted and the source and account may be attempted to be balanced against the 2D amounts, from which it may continue to block 316 and/or block 318. At block 312, a determination may be made whether optical character recognition (OCR) can be performed. Moreover, the OCR may be performed by a specializing OCR performing device and/or a specialized computer having specialized instructions for the OCR. If the OCR can be performed, then the operation may proceed to block 318. If OCR cannot be performed, then the operation may proceed to block 316. At block 318, the source translation may be looked up and at block 322, a determination may be made whether the source code is valid. If at block 322 the source code is valid, then the operation may proceed to block 316 or block 318. If the source code is not valid, then the operation may proceed to block 320. At block 320, the transactions may be processed in the queue for account and source code correction as a part of the queue workflow. At block 316, the transactions may be checked for flagging as ID ME for special handling/processing. If the transaction is flagged as ID ME, then the operation may proceed to block 324. At block 324, the transactions may be processed in the queue for ID ME special handling/processing as a part of the queue workflow. The operation may proceed to block 330 of FIG. 3B. If at block 316, the transaction is not flagged as ID ME, then the operation may proceed to block 336 of FIG. 3B.

At block 328, a determination may be made if the donation included credit card information. If the donation included credit card information, then the operation may proceed to block 326. At block 326, the donation may be flagged as including credit card information or a credit card payment. The operation may proceed to block 310. If the donation does not include credit card information, then the operation may proceed to block 348 of FIG. 3B, a queue workflow for correspondence creation.

At block 330, a determination is made whether the transactions that have been processed in the queue for ID ME special handling/processing as a part of the queue workflow is depositable. If yes, then the operation may optionally proceed to block 334 or may proceed to block 336. If no, then the operation may proceed to block 332. At block 334, the transaction and/or tray may proceed to a queue workflow for offline data entry. At block 336, the transaction and/or tray may proceed to a queue workflow for balancing and product identification.

At block 332, the transaction and/or tray may proceed to a queue workflow for maintenance required. After this workflow for maintenance at block 332, the transaction and/or tray may be determined to be depositable or not at block 338. If the transaction and/or tray is determined to be depositable, then the transaction and/or tray may proceed to block 336, a queue workflow for balancing and product identification. If the transaction and/or tray is determined not to be depositable, the transaction and/or tray may proceed to block 348, a queue workflow for correspondence creation. After processing by the queue workflow for correspondence creation at block 348, the transaction and/or tray may proceed to block 366, external calls through a module called Studio Enterprise.

At block 340, the transaction and/or tray may proceed to external calls to the client ERP (e.g., through a module called Studio Enterprise, as depicted). This may be in conjunction with gift look-ups. Additionally or alternatively, the transaction may be checked to see if it needs to be sent to maintenance at block 342. If yes, the transaction and/or tray may proceed to block 332, a queue workflow for maintenance required 332. Alternatively or additionally, the transaction and/or tray may proceed to block 354 as a check for credit card. If yes, then the transaction and/or tray may proceed to block 352 a queue workflow for credit card authorization. If no, the transaction and/or tray may proceed to block 356, a check for valid MICR.

After block 352, the transaction and/or tray may proceed to block 350, a check for approval. If no, the transaction and/or tray may proceed to block 348, a queue workflow for correspondence creation. If yes, the transaction and/or tray may proceed to block 360, a check for completed ECP transaction(s).

As mentioned at block 356, a check for a valid MICR may be performed. If no, the transaction and/or tray may proceed to block 358, a queue workflow for MICR correction. If yes, the transaction and/or tray may proceed to block 360, a check for completed ECP transaction(s).

At block 360, the transaction and/or tray may proceed to block 362, a module for DD SE batch creation. At block 362, the transaction and/or tray may proceed to block 363, a module for DD SE deposit creation. Further, at block 364 the transaction and/or tray may be outputted in output files, optionally including ICL and image pointers.

### Computer Program Products, Methods, and Computing Entities

Embodiments of the present disclosure may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain processes or operations. Thus, embodiments of the present disclosure may also take the form of an entirely hardware embodiment, an entirely computer program product embodiment, and/or an embodiment that comprises combination of computer program products and hardware performing certain processes or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, processes, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the processes or operations specified in the block diagrams and flowchart illustrations. Accordingly, the block diagrams and flowchart illustrations support various combinations of embodiments for performing the specified instructions, operations, or processes.

### Exemplary System Architecture

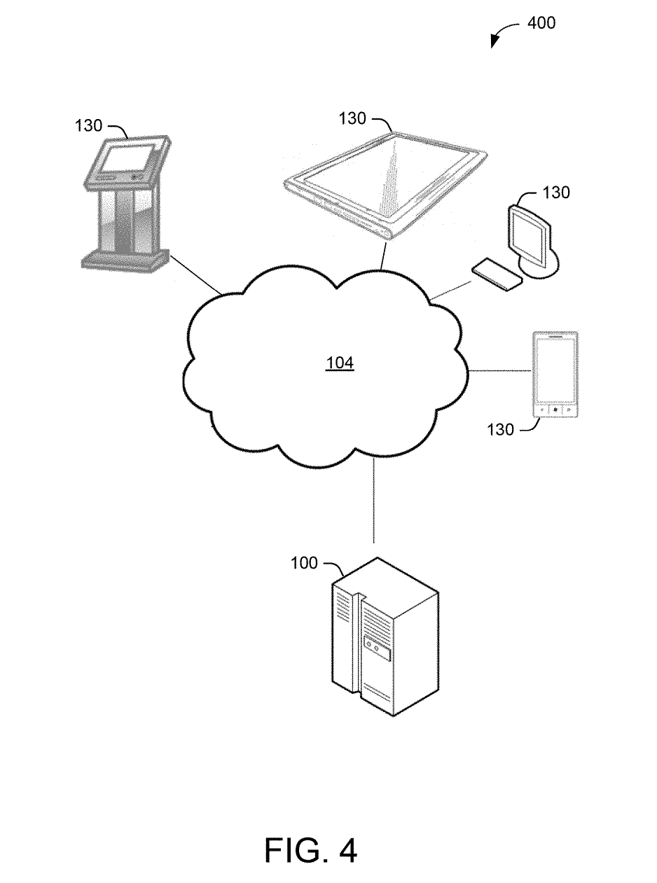

FIG. 4 provides an illustration of an exemplary embodiment of the present disclosure. As shown in FIG. 4, this particular embodiment may include one or more management computing entities 100 (also referred to as ECP system(s) above), one or more networks 104, and one or more user computing entities 130. Each of these components, entities, devices, systems, and similar words used herein interchangeably may be in direct or indirect communication with, for example, one another over the same or different wired or wireless networks. Additionally, while FIG. 4 illustrates the various system entities as separate, standalone entities, the various embodiments are not limited to this particular architecture.

### Exemplary Management Computing Entity

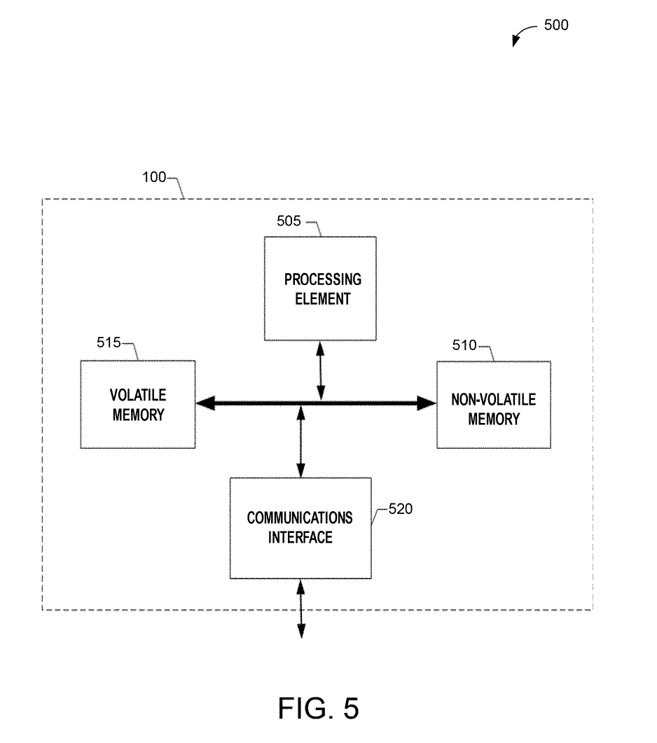

FIG. 5 provides a schematic of a management computing entity 100 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the management computing entity 100 may also include one or more communications interfaces 520 for communicating with various computing entities, such as by communicating data, content, information, and/or similar terms used herein interchangeably that may be transmitted, received, operated on, processed, displayed, stored, and/or the like. For instance, the carrier computing entity 100 may communicate with user computing entities 130 and/or a variety of other computing entities.

As shown in FIG. 5, in one embodiment, the carrier computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 505 may be embodied in a number of different ways. For example, the processing element 505 may be embodied as one or more complex programmable logic devices (CPLDs), microprocessors, multi-core processors, coprocessing entities, application-specific instruction-set processors (ASIPs), microcontrollers, and/or controllers. Further, the processing element 505 may be embodied as one or more other processing devices or circuitry. The term circuitry may refer to an entirely hardware embodiment or a combination of hardware and computer program products. Thus, the processing element 505 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 505 may be configured for a particular use or configured to execute instructions stored in volatile or non-volatile media or otherwise accessible to the processing element 505. As such, whether configured by hardware or computer program products, or by a combination thereof, the processing element 505 may be capable of performing or operations according to embodiments of the present disclosure when configured accordingly.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 510, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 515, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 505. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 100 with the assistance of the processing element 505 and operating system.

As indicated, in one embodiment, the management computing entity 100 may also include one or more communications interfaces 520 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 100 may include or be in communication with one or more input elements, such as a keyboard input, a mouse input, a touch screen/display input, motion input, movement input, audio input, pointing device input, joystick input, keypad input, and/or the like. The carrier computing entity 100 may also include or be in communication with one or more output elements (not shown), such as audio output, video output, screen/display output, motion output, movement output, and/or the like.

As will be appreciated, one or more of the management computing entity's 100 components may be located remotely from other management computing entity 100 components, such as in a distributed system. Furthermore, one or more of the components may be combined and additional components performing functions described herein may be included in the management computing entity 100. Thus, the management computing entity 100 may be adapted to accommodate a variety of needs and circumstances. As will be recognized, these architectures and descriptions are provided for exemplary purposes only and are not limiting to the various embodiments.

### Exemplary User Computing Entity

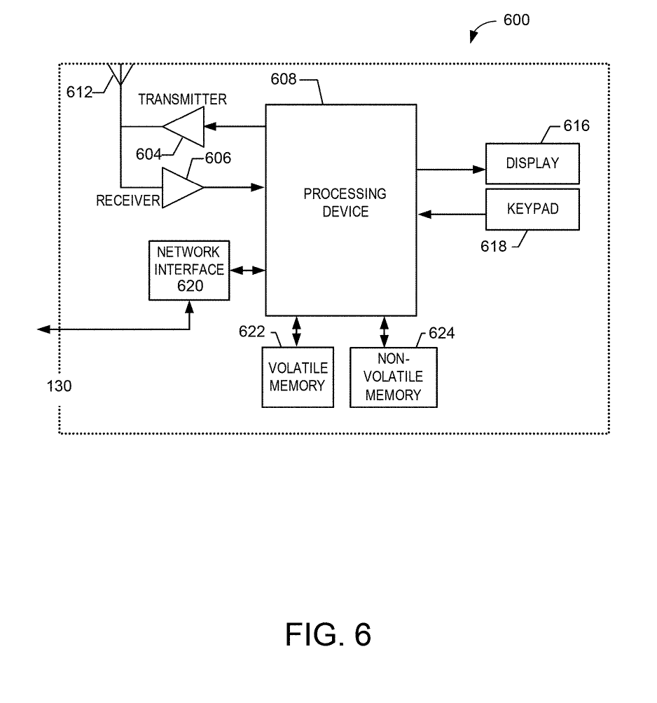

A user may be an individual, a family, a company, an organization, an entity, a department within an organization, a representative of an organization and/or person, and/or the like. In one example, users may be carrier personnel, consignors/shippers, consignees/recipients, and/or the like. For instance, a user may operate a user computing entity 510 that includes one or more components that are functionally similar to those of the carrier computing entity 100. FIG. 6 provides an illustrative schematic representative of a user computing entity 130 that may be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 130 may be operated by various parties. As shown in FIG. 6, the user computing entity 130 may include an antenna 612, a transmitter 604 (e.g., radio), a receiver 606 (e.g., radio), and a processing element 608 (e.g., CPLDs, microprocessors, multi-core processors, coprocessing entities, ASIPs, microcontrollers, and/or controllers) that provides signals to and receives signals from the transmitter 604 and receiver 606, respectively.

The signals provided to and received from the transmitter 604 and the receiver 606, respectively, may include signaling information in accordance with air interface standards of applicable wireless systems. In this regard, the user computing entity 130 may be capable of operating with one or more air interface standards, communication protocols, modulation types, and access types. More particularly, the user computing entity 130 may operate in accordance with any of a number of wireless communication standards and protocols, such as those described above with regard to the carrier computing entity 100. In a particular embodiment, the user computing entity 130 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 130 may operate in accordance with multiple wired communication standards and protocols, such as those described above with regard to the carrier computing entity 100 via a network interface 620.

Via these communication standards and protocols, the user computing entity 130 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 may also download changes, add-ons, and updates, for instance, to its firmware, software (e.g., including executable instructions, applications, program modules), and operating system.

According to one embodiment, the user computing entity 130 may include location determining aspects, devices, modules, functionalities, and/or similar words used herein interchangeably. For example, the user computing entity 130 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information may be determined by triangulating the user computing entity's 130 position in connection with a variety of other systems, including cellular towers, Wi-Fi access points, and/or the like. Similarly, the user computing entity 130 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The user computing entity 130 may also comprise a user interface (that may include a display 616 coupled to a processing element 608) and/or a user input interface (coupled to a processing element 608). For example, the user interface may be a user application, browser, user interface, and/or similar words used herein interchangeably executing on and/or accessible via the user computing entity 130 to interact with and/or cause display of information from the carrier computing entity 100, as described herein. The user input interface may comprise any of a number of devices or interfaces allowing the user computing entity 130 to receive data, such as a keypad 618 (hard or soft), a touch display, voice/speech or motion interfaces, or other input device. In embodiments including a keypad 618, the keypad 618 may include (or cause display of) the conventional numeric (0-9) and related keys (#, *), and other keys used for operating the user computing entity 130 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The user computing entity 130 may also include volatile storage or memory 622 and/or non-volatile storage or memory 624, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the user computing entity 130. As indicated, this may include a user application that is resident on the entity or accessible through a browser or other user interface for communicating with the management computing entity 100 and/or various other computing entities.

In another embodiment, the user computing entity 130 may include one or more components or functionality that are the same or similar to those of the carrier computing entity 100, as described in greater detail above. As will be recognized, these architectures and descriptions are provided for exemplary purposes only and are not limiting to the various embodiments.

### Additional Implementation Details

Although an example processing system has been described above, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a client computer having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) may be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### CONCLUSION

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method, comprising:
receiving, by a management computing system, a first batch from a first device, the batch comprising a plurality of transactions;
disintegrating, by the management computing system, the first batch into a plurality of individual transaction; and
processing, by the management computing system, the plurality of individual transactions by one or more workflows.

2. The method of claim 1, further comprising:
combining the plurality of individual transaction into a second batch in response to the processing of the plurality of individual transactions by one or more workflows.

3. The method of claim 2, further comprising:
sending the second batch to one or more legacy devices.

4. The method of claim 1, further comprising:
tracking, by the management computing system, the plurality of individual transactions during the processing of the plurality of individual transactions by one or more workflows.

5. The method of claim 4, further comprising:
sending the tracked plurality of individual transactions to one or more consumer devices for presentation to one or more users.

6. The method of claim 1, further comprising:
performing optical character recognition (OCR) on one or more of the plurality of individual transaction during the processing of the plurality of individual transactions by one or more workflows.

7. A device comprising:
at least one memory that stores computer-executable instructions;
at least one processor configured to access the at least one memory and execute the computer-executable instructions to:
receive a first batch from a first device, the batch comprising a plurality of transactions;
disintegrate the first batch into a plurality of individual transaction; and
process the plurality of individual transactions by one or more workflows.

8. The device of claim 7, wherein the at least one processor is further configured to access the at least one memory and execute the computer-executable instructions to:
combine the plurality of individual transaction into a second batch in response to the processing of the plurality of individual transactions by one or more workflows.

9. The device of claim 8, wherein the at least one processor is further configured to access the at least one memory and execute the computer-executable instructions to:
send the second batch to one or more legacy devices.

10. The device of claim 7, wherein the at least one processor is further configured to access the at least one memory and execute the computer-executable instructions to:
track the plurality of individual transactions during the processing of the plurality of individual transactions by one or more workflows.

11. The device of claim 10, wherein the at least one processor is further configured to access the at least one memory and execute the computer-executable instructions to:
send the tracked plurality of individual transactions to one or more consumer devices for presentation to one or more users.

12. The device of claim 7, wherein the at least one processor is further configured to access the at least one memory and execute the computer-executable instructions to:
perform optical character recognition (OCR) on one or more of the plurality of individual transaction during processing of the plurality of individual transactions by one or more workflows.

13. A computer-readable medium storing computer-executable instructions which, when executed by a processor, cause the processor to perform operations comprising:
receiving a first batch from a first device, the batch comprising a plurality of transactions;
disintegrating the first batch into a plurality of individual transaction; and
processing the plurality of individual transactions by one or more workflows.

14. The computer-readable medium of claim 13, the operations further comprising:
combining the plurality of individual transaction into a second batch in response to the processing of the plurality of individual transactions by one or more workflows.

15. The computer-readable medium of claim 14, the operations further comprising:
sending the second batch to one or more legacy devices.

16. The computer-readable medium of claim 13, the operations further comprising:
tracking the plurality of individual transactions during the processing of the plurality of individual transactions by one or more workflows.

17. The computer-readable medium of claim 16, the operations further comprising:
sending the tracked plurality of individual transactions to one or more consumer devices for presentation to one or more users.

18. The computer-readable medium of claim 13, the operations further comprising:
performing optical character recognition (OCR) on one or more of the plurality of individual transaction during the processing of the plurality of individual transactions by one or more workflows.
